(19) United States
(12) Patent Application Publication
(10) Pub. No.: US 2012/0307055 A1
(43) Pub. Date: Dec. 6, 2012

(54) IMAGE SURVEILLANCE SYSTEM, IMAGE CAPTURING APPARATUS AND MULTIMEDIA APPARATUS

(75) Inventors: Chen-Liang Li, Hsinchu County (TW); Sheng-Jie Chen, Hsinchu County (TW); Chia-Hung Lin, Hsinchu City (TW)

(73) Assignee: SONIX TECHNOLOGY CO., LTD., Hsinchu (TW)

(21) Appl. No.: 13/485,944

(22) Filed: Jun. 1, 2012

(30) Foreign Application Priority Data
Jun. 2, 2011 (TW) 100119406

(51) Int. Cl. H04N 7/18

(52) U.S. Cl. 348/143; 348/E07.085

(57) ABSTRACT

An image surveillance system, an image capturing apparatus, and a multimedia apparatus are provided. The image surveillance system includes an image capturing module, a first digital modulating module, a second digital modulating module, and a multimedia module. The image capturing module produces an image signal. The first digital modulating module includes a first digital modulator and a first analog-to-digital/digital-to-analog (AD/DA) converter to receive the image signal and modulate the same into a digital stream. The second digital modulating module includes a second digital modulator and a second AD/DA converter and is connected to the first AD/DA converter through a coaxial cable. The second digital modulator receives the digital stream and modulates the digital stream into image data. The multimedia module is electrically connected to the second digital modulating module and receives the image data.

### CROSS-REFERENCE TO RELATED APPLICATION

This application claims the priority benefit of Taiwan application serial no. 100119406, filed on Jun. 2, 2011. The entirety of the above-mentioned patent application is hereby incorporated by reference herein and made a part of this specification.

### BACKGROUND OF THE INVENTION

1. Field of the Invention

The invention relates to a security surveillance system, and more particularly to an image surveillance system and an image surveillance apparatus.

2. Description of Related Art

A composite video baseband signal (CVBS) generated by a camera sensor with ISP (an analog surveillance system) is an analog signal. In a conventional security surveillance system, the analog CVBS signal is applied to directly transmit an image signal through a coaxial cable. However, only the uncompressed image signal is likely to be transmitted through the coaxial cable, which imposes a restriction on image quality and transmission distance. Moreover, the receiving end is merely able to display the received image signal. The continuous advancement of technologies not only results in the increasing demands of consumers for image quality (e.g., image resolution) but also leads to the requirement by the security surveillance system for transmission of high definition (HD) images with storable data. Hence, the conventional security surveillance system which fails to comply with said requirement is no longer sufficient.

In another conventional security surveillance system operated based on network connection, an internet protocol (IP) camera is necessitated. FIG. 1 is a block diagram illustrating a conventional network-based security surveillance system. With reference to FIG. 1, in the conventional network-based security surveillance system, an image capturing apparatus 1 includes a network surveillance camera 2 and a network physical layer 3. The network surveillance camera 2 has a built-in computer processing system and a designated IP address. The retrieved data need be compressed and stored in a packet that conforms to the network transmission standard, and the packet is transmitted to Ethernet network through the network physical layer 3. The transmission line 4 herein refers to a twisted-pair cable. Hence, any additional image capturing apparatus 1 requires a corresponding network physical layer 3′ configured at the receiving end, so that the packet can be accurately received and transmitted to an image output apparatus 5. However, the increase in the number of network surveillance cameras 2 at the transmitting end leads to the corresponding increase in the number of network physical layers 3′, and thereby the costs of establishing the network security surveillance system are also increased.

Furthermore, image compression may be an obstacle to a network surveillance camera in a real-time security surveillance system, and unstable network connection may frequently cause signal delay in the real-time surveillance or even cause packet loss. The recently developed million pixel images even worsen said issues. At present, the majority of image surveillance systems are still analog systems. Hence, given that a user who prefers HD images is concerned for unstable network transmission and does not intend to replace the entire analog surveillance system (e.g., the user may wish to continuously use a coaxial cable as the transmission line), the user inevitably needs a solution to the conventional analog systems.

### SUMMARY OF THE INVENTION

The invention is directed to an image surveillance system, an image capturing apparatus configured for an image surveillance system, and a multimedia apparatus configured for an image surveillance system. According to an embodiment of the invention, HD images may be directly compressed, modulated into digital streams, transmitted to the multimedia apparatus through a transmission line, and displayed or stored.

In an embodiment of the invention, an image surveillance system that includes an image capturing module, a first digital modulating module, a second digital modulating module, and a multimedia module is provided. The image capturing module produces an image signal. The first digital modulating module includes a first digital modulator and a first analog-to-digital/digital-to-analog (AD/DA) converter. The first digital modulator is electrically connected to the image capturing module, receives the image signal, and modulates the image signal into a digital stream. The second digital modulating module includes a second digital modulator and a second AD/DA converter, the second AD/DA converter is connected to the first AD/DA converter through a coaxial cable, and the second digital modulator receives the digital stream and demodulates the digital stream into image data. The multimedia module is electrically connected to the second digital modulating module and receives the image data.

According to an embodiment of the invention, the second digital modulating module further transmits a control signal to the first digital modulating module through the coaxial cable and controls the image capturing module to perform a function.

According to an embodiment of the invention, the image surveillance system further includes a pan tilt zoom (PTZ) control module that is electrically connected to the first digital modulating module to control a capturing direction of the image capturing module and to produce a zoom-in or zoom-out image signal.

According to an embodiment of the invention, the image capturing module further compresses the image signal by applying an image compression standard, and the image capturing module provides the first digital modulating module with the compressed image signal for modulation.

According to an embodiment of the invention, the image compression standard includes an H.264 compression standard, a moving picture expert group 4 (MPEG-4) compression standard, or a motion joint photographic coding expert group (MJPEG) compression standard.

According to an embodiment of the invention, the first digital modulating module is connected to the image capturing module through a first data transmission interface. Here, the first data transmission interface is a serial peripheral interface (SPI), a universal serial bus (USB) interface, or a secure digital input/output (SDIO) interface.

According to an embodiment of the invention, the multimedia module is connected to the second digital modulating module through a second data transmission interface. Here, the second data transmission interface is an SPI, a USB interface, or an SDIO interface.

According to an embodiment of the invention, the first digital modulator and the second digital modulator adopt a modulating scheme that includes orthogonal frequency divisional multiplexing (OFDM), frequency shift keying (FSK), or phase shift keying (PSK).

According to an embodiment of the invention, the image capturing module receives electric power and a control signal through the coaxial cable.

In another embodiment of the invention, an image capturing apparatus configured for an image surveillance system is provided. The image capturing apparatus includes a lens module, a photosensitive device, an image signal processing module, a first digital modulating module, and a coaxial cable joint. The photosensitive device senses a light source received by the lens module and produces an image signal. The image signal processing module is coupled to the photosensitive device and performs an image processing task on the image signal. The first digital modulating module includes a first digital modulator and a first AD/DA converter. The first digital modulator is electrically connected to the image processing module, receives the image signal processed by the image processing module, and modulates the image signal into a digital stream. The coaxial cable joint is electrically connected to the first AD/DA converter to transmit the digital stream to a multimedia module through a coaxial cable for displaying or storing.

In still another embodiment of the invention, a multimedia apparatus configured for an image surveillance system and adapted to receive a digital stream produced by an image capturing apparatus is provided. The multimedia apparatus includes a coaxial cable joint, a second digital modulating module, and a multimedia module The second digital modulating module is electrically connected to the coaxial cable joint and includes a second digital modulator and a second AD/DA converter. The second digital modulating module receives the digital stream through the coaxial cable joint that is connected to a coaxial cable, and the second digital modulating module demodulates the digital stream into image data. The multimedia module is connected to the second digital modulating module through a second data transmission interface, receives the image data modulated by the second digital modulating module, and displays or stores the image data.

In still another embodiment of the invention, an image surveillance system that includes an image capturing module, a first digital modulating module, a second digital modulating module, and a multimedia module is provided. The image capturing module produces an image signal. The first digital modulating module includes a first digital modulator and a first AD/DA converter. The first digital modulator is electrically connected to the image capturing module, receives the image signal, and modulates the image signal into a digital stream. The second digital modulating module includes a second digital modulator and a second AD/DA converter, the second AD/DA converter is connected to the first AD/DA converter through a transmission line, and the second digital modulator receives the digital stream and demodulates the digital stream into image data. The multimedia module is electrically connected to the second digital modulating module and receives the image data. Here, the image capturing module receives electric power and a control signal through the transmission line.

According to an embodiment of the invention, the transmission line is a coaxial cable, a power line, or an Ethernet network cable.

In view of the above, the data transmission interface that supports a bidirectional data transmission protocol is applied in the invention, and analog image signals may be transmitted in form of digital streams through conducting the digital modulation and digital demodulation technologies. Here, the transmission of image signals is bidirectional.

Other features and advantages of the invention will be further understood from the further technological features disclosed by the embodiments of the invention wherein there are shown and described embodiments of this invention, simply by way of illustration of modes best suited to carry out the invention.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a block diagram illustrating a conventional network security surveillance system.

FIG. 2 is a block diagram illustrating an image surveillance system according to an embodiment of the invention.

FIG. 3 is a block diagram illustrating an image surveillance system according to another embodiment of the invention.

FIG. 4 is a schematic view illustrating a SPI according to an embodiment of the invention.

FIG. 5 is a block diagram illustrating an image surveillance system according to still another embodiment of the invention.

FIG. 6 is a block diagram illustrating an image surveillance system according to still another embodiment of the invention.

FIG. 7 is a block diagram illustrating an image capturing apparatus according to an embodiment of the invention.

FIG. 8 is a block diagram illustrating a multimedia apparatus according to an embodiment of the invention.

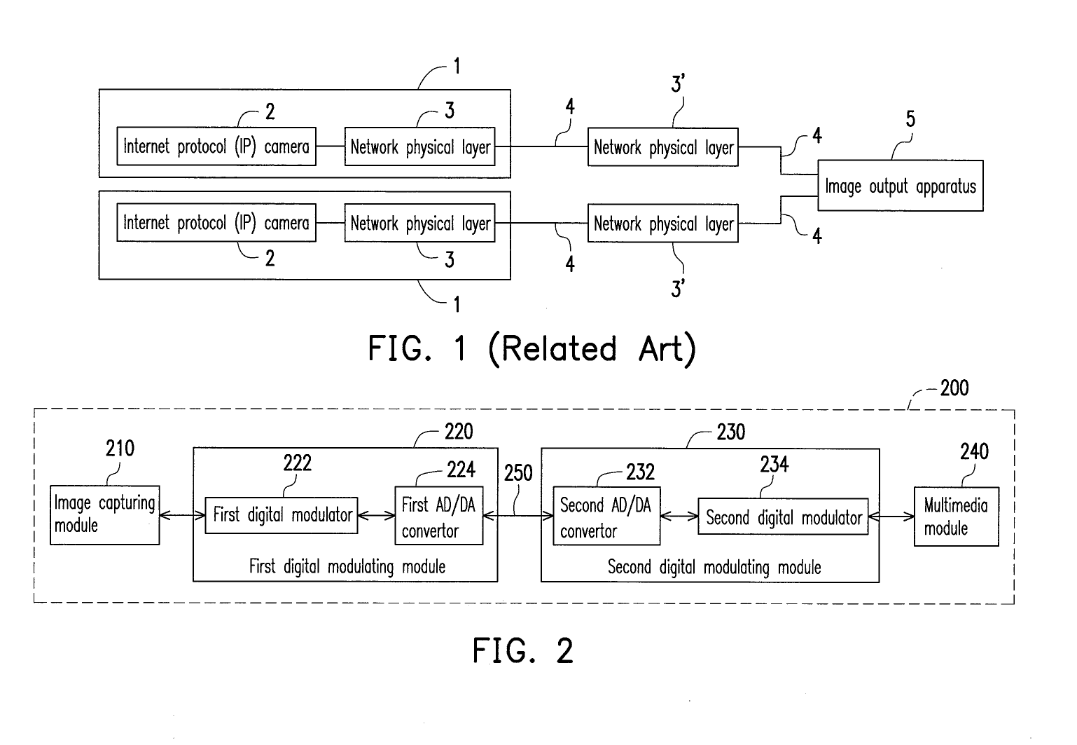

### DESCRIPTION OF EMBODIMENTS

In an embodiment of the invention, after the image capturing apparatus captures an image, the image signal is compressed or otherwise processed and then transmitted to a first digital modulating module through a data transmission interface that supports a bidirectional data transmission protocol, such that the image signal may be modulated into a digital stream. The digital stream may be transmitted to a multimedia apparatus through a coaxial cable or a transmission line for displaying or storing, which realizes transmission of HD images. The data transmission interface that supports a bidirectional data transmission protocol is cost-effective, thus economizing the costs of the entire image surveillance system. In order to make the invention more comprehensible, embodiments are described below as the examples to prove that the invention can actually be realized.

FIG. 2 is a block diagram illustrating an image surveillance system according to an embodiment of the invention. The image surveillance system 200 includes an image capturing module 210, a first digital modulating module 220, a second digital modulating module 230, and a multimedia module 240. The first digital modulating module 220 includes a first digital modulator 222 and a first AD/DA converter 224. The first digital modulator 222 is electrically connected to the image capturing module 210, receives the image signal, and modulates the image signal into a digital stream. The second digital modulating module 230 includes a second digital modulator 234 and a second AD/DA converter 232. The second AD/DA converter 232 is connected to the first AD/DA converter 224 through a coaxial cable 250, and the second digital modulator 232 receives the digital stream and modulates the digital stream into image data. The multimedia module 240 is electrically connected to the second digital modulator 234 and receives the image data. The second digital modulating module 230 further transmits a control signal to the first digital modulating module 220 through the coaxial cable 250 and controls the image capturing module 210 to perform a function.

In the embodiment shown in FIG. 2, data are transmitted between the image capturing module 210 and the first digital modulating module 220 through the data transmission interface that supports a bidirectional data transmission protocol, and so is the data transmission between the second digital modulating module 230 and the multimedia module 240. Another embodiment is provided hereinafter for describing the invention.

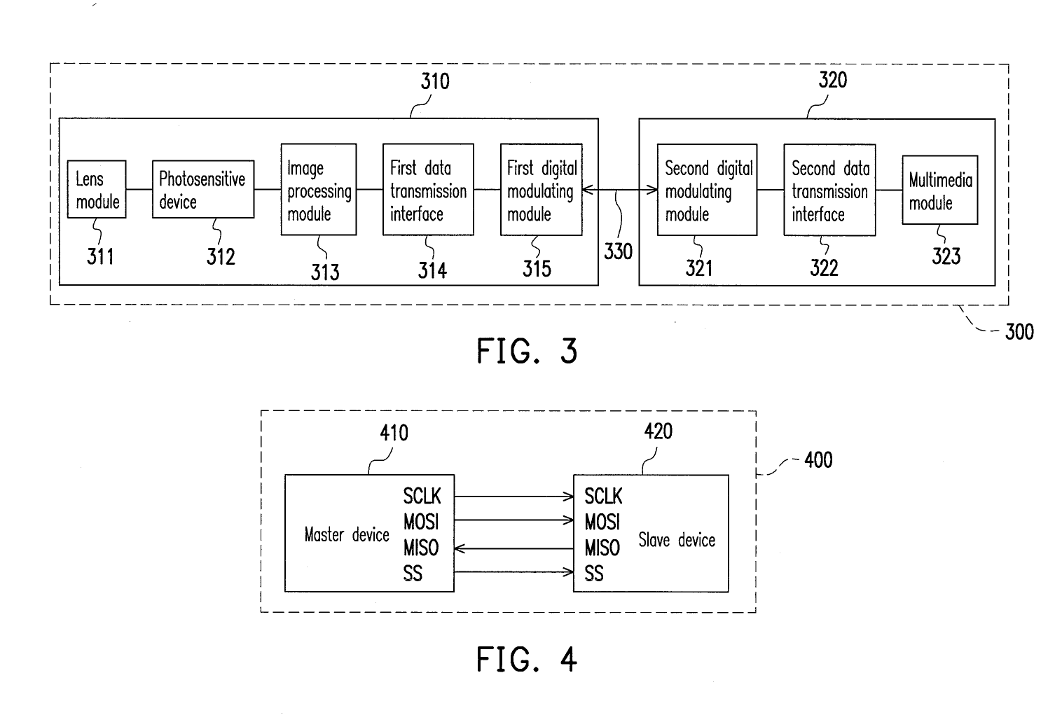

FIG. 3 is a block diagram illustrating an image surveillance system according to another embodiment of the invention. With reference to FIG. 3, the image surveillance system 300 described in the present embodiment includes an image capturing apparatus 310 and a multimedia apparatus 320 that are applicable to an image surveillance system. The image capturing apparatus 310 includes a lens module 311, a photosensitive device 312, an image processing module 313, a first data transmission interface 314, and a first digital modulating module 315. The multimedia apparatus 320 includes a second digital modulating module 31, a second data transmission interface 322, and a multimedia module 323. The functions of these devices are respectively described below.

In the image capturing apparatus 310, the photosensitive device 312 is, for instance, a charge coupled device (CCD) or a complementary metal oxide semiconductor (CMOS), and the photosensitive device 312 may be applied to sense a light source received by the lens module 311 and produce an image signal.

The image processing module 313 is coupled to the photosensitive device 312 and may process image signals in different ways, e.g., image transmission and compression, motion detection of dynamic images, watermark or text insertion, and so forth. To be more specific, in an embodiment of the invention, the image processing module 313 may include an image compression unit that can compress image signals by employing different image compression standards. The image compression standard includes an H.264 compression standard, an MPEG-4 compression standard, or an MJPEG compression standard. The H.264 compression standard or the MPEG-4 compression standard is characterized by high compression ratio as well as low bit rate and is highly capable of being integrated with communication applications. Besides, simple application programs are applicable under the H.264 compression standard or the MPEG-4 compression standard. Therefore, these standards are suitable for the HD image surveillance system described herein.

The first digital modulating module 315 is connected to the image processing module 313 through the first data transmission interface 314 that supports a first bidirectional data transmission protocol, so as to receive the image signal processed by the image processing module 313 and modulate the image signal into a digital stream. According to an embodiment of the invention, the first digital modulating module 315 modulates the image signal by adopting a digital signal modulating scheme that exemplarily includes OFDM, FSK, PSK, continuous phase modulation (CPM), or quadrature amplitude modulation (QAM). Here, the digital signal modulating scheme may be determined based on the required bandwidth, the required transmission distance, or the required channel model if certain data transmission rate needs to be achieved.

From another perspective, the second digital modulating module 321 in the multimedia module 320 is connected to the first digital modulating module 315 of the image capturing apparatus 310 through a transmission line 330, so as to receive the digital stream modulated by the first digital modulating module 315 and the second digital modulating module 321 demodulate the received digital stream into image data. The multimedia module 323 is connected to the second digital modulating module 321 through a second data transmission interface 322, so as to receive the image data generated by the second digital modulating module 321 and display or store the image data.

According to an embodiment of the invention, the second digital modulating module 321 transmits a control signal to the first digital modulating module 315 through the coaxial cable 30 and controls the image capturing device 310 to perform a function. Namely, when the image capturing apparatus 310 (acting as a transmitting end) transmits the image signal to the multimedia apparatus 320 (acting as a receiving end), the first digital modulating module 315 performs the modulating function, while the second digital modulating module 321 performs the demodulating function. On the contrary, when the multimedia apparatus 320 (acting as a transmitting end) transmits the control signal to the image capturing apparatus 310 (acting as a receiving end), the second digital modulating module 321 performs the modulating function, while the first digital modulating module 315 performs the demodulating function. That is to say, the first and second digital modulating modules 315 and 321 are both capable of performing the modulating and demodulating functions. Thereby, the image surveillance system 300 is characterized by bidirectional communication and transmission.

Since the first and second digital modulating modules 315 and 321 can perform the same functions, the hardware design of the first and second digital modulating modules 315 and 321 may be the same. However, in another embodiment of the invention, the second digital modulating module 321 may be coupled to a plurality of multimedia modules 323. Here, the modulating and demodulating functions that can be performed by the second digital modulating module 321 are basically the same as those discussed above, while the design described herein is relatively complex. In consideration of complexity, a user can determine the hardware design of the second digital modulating module 321 based on actual requirements, which should not be construed as a limitation to the invention. Nonetheless, regardless of the same or different hardware design of the first and second digital modulating modules 315 and 321, the same digital signal modulating scheme (e.g., OFDM) may be employed.

The transmission line 330 may be a coaxial cable, a power line, an ethernet network cable, or any other cable capable of supporting digital signal transmission, which should not be construed as a limitation to the invention. The first data transmission interface 314 and the second data transmission interface 322 are, for instance, SPI, USB interfaces, SDIO interfaces, or a combination thereof. These three data transmission interfaces are respectively elaborated hereinafter.

FIG. 4 is a schematic view illustrating a SPI according to an embodiment of the invention. With reference to FIG. 4, the SPI 400 includes a master device 410, a slave device 420, and four signal wires which are serial clock (SCLK), master-out and slave-in (MOSI), master-in and slave-out (MISO), and slave select (SS). The SPI 400 is a four-wire synchronous serial data protocol and has a master/slave structure. The master device 410 provides the serial clock signal and can read data from or write data into the slave device 420. Hence, the transmission speed may be determined by controlling the frequency of the serial clock signal SCLK. The SPI 400 is a simple hardware interface that does not require a great number of traces (less circuitry) and is often employed by 8051 microcontrollers, and the transmission speed of the SPI 400 may conform to the transmission of image signals. Hence, the SPI 400 may appropriately serve as the first data transmission interface 314 in the image surveillance system 300 described in the present embodiment.

If the data transmission interface in the invention refers to a USB interface, the USB interface may be a standard USB interface, a mini USB interface, or a micro USB interface. In the standard USB interface, USB signals are transmitted on a twisted-pair data cable respectively labeled as D+ and D−. The bidirectional data transmission protocol applied to the USB interface may have the USB 2.0 specification, the USB 3.0 specification, or any other specification equivalent to or higher than the USB 3.0 specification, which should not be construed as a limitation to the invention.

Secure digital (SD) memory cards are extensively applied to portable devices, e.g., digital cameras, personal digital assistants (PDA), multimedia players, and so on. The SDIO interface is literally defined as an SD input/output interface, i.e., the SD card is connected to external peripheral devices through its I/O pins, such that data transmission between the SD card and the external peripheral devices is allowed. In brief, the SDIO interface with development flexibility facilitates the connection to peripheral devices. Hence, the SDIO interface may appropriately serve as the first data transmission interface 314 in the image surveillance system 300 described herein.

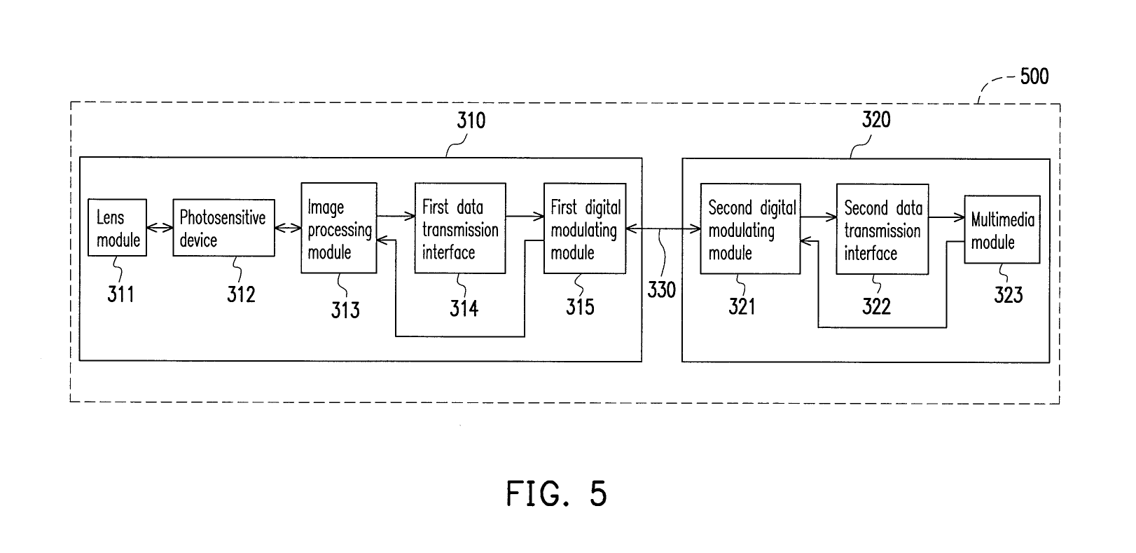

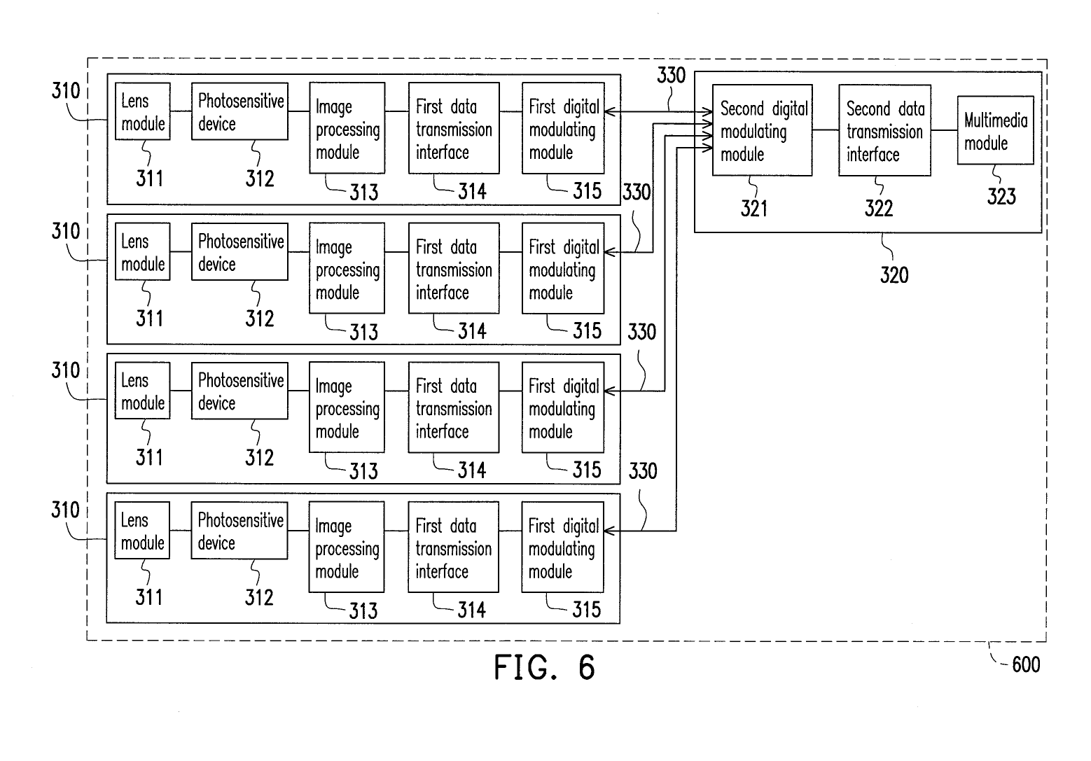

Another embodiment is further provided hereinafter to elaborate the bidirectional data transmission properties of the image surveillance system. FIG. 5 is a block diagram illustrating an image surveillance system according to still another embodiment of the invention. With reference to FIG. 5, the image surveillance system 500 described in the present embodiment includes an image capturing apparatus 310 and a multimedia apparatus 320. Here, the bidirectional data transmission between the image capturing apparatus 310 and the multimedia apparatus 320 is different from that provided in the previous embodiment.

Specifically, the photosensitive device 312 transmits an image signal in the RGB format or the YUV format (also known as the YCrCb format) to the image processing module 120 for analog-to-digital conversion or image compression. In the RGB coding format, each color is represented by intensities of three variables (red, green, and blue). By contrast, in the YUV coding format, Y denotes the luminance component, and U and V are chrominance components, respectively.

The first digital modulating module 315 is connected to the image processing module 313 through the first data transmission interface 314 that supports a first bidirectional data transmission protocol, so as to receive the image signal processed by the image processing module 313 and modulate the image signal into a digital stream. The digital stream may be transmitted to the second digital modulating module 321 through the transmission line 330. The multimedia module 323 is connected to the second digital modulating module 321 through the second data transmission interface 322 that supports a second bidirectional data transmission protocol, so as to receive the digital stream demodulated by the second digital modulating module 321 and display or store the demodulated digital stream.

According to an embodiment of the invention, the second digital modulating module 210 may receive a control signal from the multimedia module 323 through an RS232 interface standardized by the Electronic Industries Alliance (EIA) or an inter integrated circuit (I2C) serial communication interface. The control signal may be transmitted from the second digital modulating module 321 to the first digital modulating module 315 through the transmission line 330. Similarly, the image processing module 313 may receive the control signal from the first digital modulating module 315 through the EIA RS232 interface or the I2C serial communication interface. In another embodiment, the second digital modulating module 321 may receive the control signal directly through the second data transmission interface 322 and transmit the control signal to the first digital modulating module 315 through the transmission line 330. Similarly, the image processing module 313 may receive the control signal from the first digital modulating module 315 directly through the first data transmission interface 314.

After that, the image processing module 313 may correspondingly process the received image according to the control signal. Alternatively, the image processing module 312 may transmit the control signal to the lens module 311 through the EIA RS232 interface or the I2C serial communication interface, so as to control the lens module 311 to capture images.

The I2C interface is frequently applied to peripheral devices where simplicity and manufacturing costs are more important than transmission speed. In a word, the image capturing apparatus 310 may transmit the image signal (in form of the digital stream) to the multimedia apparatus 320 through the transmission line 330, and the multimedia apparatus 320 may transmit the control signal to the image capturing apparatus 310 through the transmission line 330, so as to control the image capturing apparatus 310 to perform certain functions. Said functions are, for instance, contrast adjustment, color tone control, color balance adjustment, and so on. Thereby, the data transmission may be bidirectional.

As discussed above, only one image capturing apparatus is applied to capture images. However, the number of the image capturing apparatuses applied in the image surveillance system can be increased in the invention, and the multimedia apparatus is capable of collecting the images from plural surveillance monitors and outputting or storing the collected images. As such, the invention is applicable in the security surveillance field and provides HD surveillance images.

FIG. 6 is a block diagram illustrating an image surveillance system according to still another embodiment of the invention. With reference to FIG. 6, an image surveillance system 600 that includes a plurality of image capturing apparatuses 310 and a multimedia apparatus 320 is provided. According to the present embodiment, the number of image capturing apparatuses 310 is four, whereas the number of image capturing apparatuses 310 is not limited in the invention and can be determined based on actual conditions. Each of the image capturing apparatuses 310 includes a lens module 311, a photosensitive device 312, an image processing module 313, and a first digital modulating module 315. The photosensitive device 312 senses a light source received by the lens module 311 and produces an image signal. The image processing module 313 is coupled to the photosensitive device 312 and performs an image processing task on the image signal. The first digital modulating module 315 is connected to the image processing module 313 through the first data transmission interface 314 that supports a first bidirectional data transmission protocol, so as to receive the image signal processed by the image processing module 313 and modulate the image signal into a digital stream.

Besides, the multimedia apparatus 320 includes a second digital modulating module 321 and a multimedia module 323. The second digital modulating module 321 is connected to the first digital modulating module 315 of each image capturing apparatus 310 through respective transmission lines 330, so as to receive the digital stream modulated by each first digital modulating module 315 and demodulate the digital stream. In another embodiment, the digital streams modulated by the first digital modulating modules 315 may be collected and transmitted to the second digital modulating module 321 through one transmission line 330. The multimedia module 323 is connected to the second digital modulating module 321 through a second data transmission interface 322 that supports a second bidirectional data transmission protocol, so as to receive the digital stream demodulated by the second digital modulating module 321 and display or store the demodulated digital stream. Here, the first digital modulating modules 315 and the second digital modulating module 321 are capable of performing the modulating and demodulating functions.

In the present embodiment, the digital streams from different image capturing apparatuses may be processed simultaneously through conducting the digital modulation technology, and therefore it is likely to increase the number of image capturing apparatuses herein. The image surveillance system 600 shown in FIG. 6 is substantially similar to the image surveillance system 300 shown in FIG. 3, and the modules in the image capturing apparatus 310 and the multimedia apparatus 320 shown in FIG. 6 perform the same or similar functions as the modules shown in FIG. 3. Differences between the image surveillance system 600 and the image surveillance system 300 are described hereinafter, while the similarity is omitted.

In the image surveillance system 600 shown in FIG. 6, the data transmission rate of digital signals transmitted from the image capturing apparatuses 310 to the multimedia apparatus 320 should be lower than the data transmission rate that can be supported by the second data transmission interface 322, and thereby the multimedia module 323 is able to acquire the digital stream demodulated by the second digital modulating module 31. In an embodiment of the invention, the second bidirectional data transmission protocol applied to the second data transmission interface 322 may have the USB 2.0 specification, the USB 3.0 specification, or any other specification equivalent to or higher than the USB 3.0 specification. The higher the data transmission rate supported by the second bidirectional data transmission protocol, the more the number of image capturing apparatuses 310 which can be simultaneously employed in the image surveillance system 600.

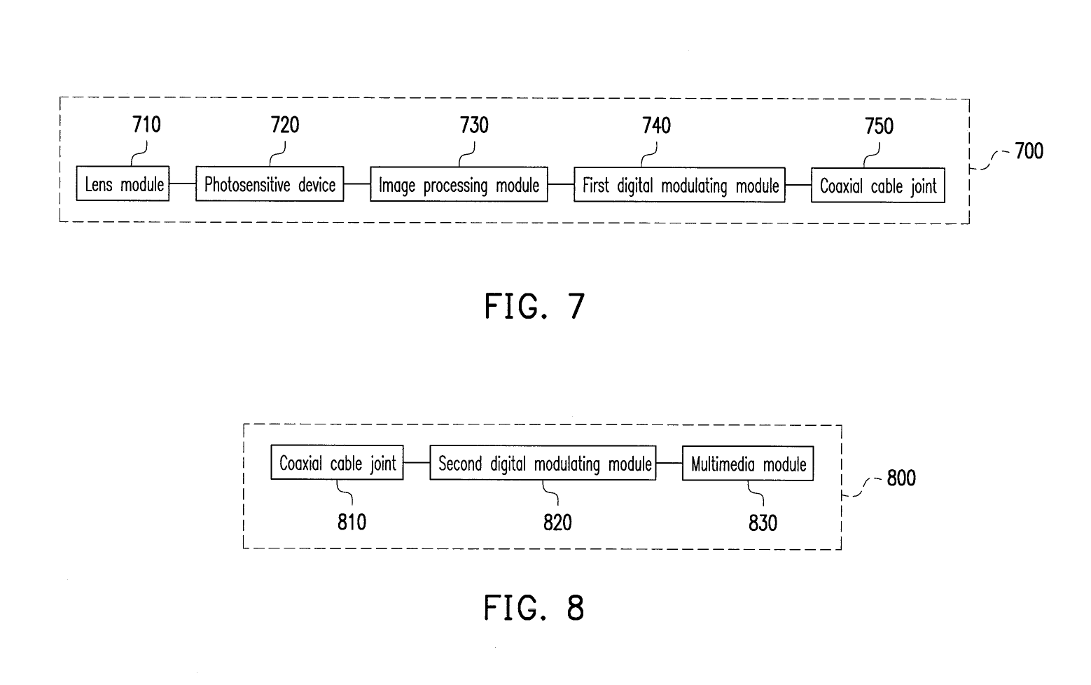

In light of the foregoing, an image capturing apparatus that is adapted to an image surveillance system is described below. FIG. 7 is a block diagram illustrating an image capturing apparatus according to an embodiment of the invention. The image capturing apparatus 700 described in the present embodiment may refer to the image capturing apparatus 310 respectively shown in FIG. 3, FIG. 5, and FIG. 6. With reference to FIG. 7, the image capturing apparatus 700 described in the present embodiment includes a lens module 710, a photosensitive device 720, an image processing module 730, a first digital modulating module 740, and a coaxial cable joint 750.

The photosensitive device 720 senses a light source received by the lens module 710 and produces an image signal. The image processing module 730 is coupled to the photosensitive device 720 and performs an image processing task on the image signal. The first digital modulating module 740 includes a first digital modulator and a first AD/DA converter. The first digital modulating module 740 is electrically connected to the image processing module 730, receives the image signal processed by the image processing module 730, and modulates the image signal into a digital stream. The coaxial cable joint 750 is electrically connected to the first AD/DA converter 740 to transmit the digital stream to a multimedia module through a coaxial cable for displaying or storing. Here, the image capturing apparatus 700 may further receive electric power and a control signal transmitted through the coaxial cable. The image capturing apparatus 700 may further include a pan tilt zoom (PTZ) control module (not shown) electrically connected to the first digital modulating module 740. The PTZ control module controls a capturing direction of the lens module 710 and produces a zoom-in or zoom-out image signal.

FIG. 8 is a block diagram illustrating a multimedia apparatus according to an embodiment of the invention. The multimedia apparatus 800 described in the present embodiment may refer to the multimedia apparatus 320 respectively shown in FIG. 3, FIG. 5, and FIG. 6. Here, the multimedia apparatus 800 includes a coaxial cable joint 810, a second digital modulating module 820, and a multimedia module 830. The second digital modulating module 820 is electrically connected to the coaxial cable joint 810 and includes a second digital modulator and a second AD/DA converter. Besides, the second digital modulating module 820 receives the digital stream through the coaxial cable joint 810 that is connected to a coaxial cable, and the second digital modulating module 820 modulates the digital stream into image data. The multimedia module 830 is connected to the second digital modulating module 820 through a second data transmission interface, receives the image data modulated by the second digital modulating module 820, and displays or stores the image data.

To sum up, the data transmission interface that supports a bidirectional data transmission protocol is applied in the embodiments of the invention, and analog image signals may be transmitted in form of digital streams through conducting the digital modulation and digital demodulation technologies. Here, the transmission of image signals is bidirectional. Additionally, even though the number of the surveillance cameras at the transmitting end is increased, it is not necessary to correspondingly increase hardware equipment at the receiving end (e.g., the same modulating module and data transmission interface may be employed). Thereby, the manufacturing costs can be reduced. Besides, since the image is compressed to reduce the amount of transmitted data according to the embodiments of the invention, the HD image can be transmitted in no need of replacing the transmission line in the conventional analog system. From another aspect, the data transmission interface described in the embodiments of the invention is cost-effective, thus economizing the costs of the entire image surveillance system.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

What is claimed is:

1. An image surveillance system comprising:
an image capturing module producing an image signal;
a first digital modulating module comprising a first digital modulator and a first analog-to-digital/digital-to-analog converter, the first digital modulator being electrically connected to the image capturing module, receiving the image signal, and modulating the image signal into a digital stream;
a second digital modulating module comprising a second digital modulator and a second analog-to-digital/digital-to-analog converter, the second analog-to-digital/digital-to-analog converter being connected to the first analog-to-digital/digital-to-analog converter through a coaxial cable, the second digital modulator receiving the digital stream and modulating the digital stream into image data; and
a multimedia module electrically connected to the second digital modulator, the multimedia module receiving the image data.

2. The image surveillance system as recited in claim 1, wherein the second digital modulating module further transmits a control signal to the first digital modulating module through the coaxial cable and controls the image capturing module to perform a function.

3. The image surveillance system as recited in claim 1, further comprising:
a pan tilt zoom control module electrically connected to the first digital modulating module to control a capturing direction of the image capturing module and to produce a zoom-in or zoom-out image signal.

4. The image surveillance system as recited in claim 1, wherein the image capturing module further compresses the image signal by applying an image compression standard, and the image capturing module provides the first digital modulating module with the compressed image signal for modulation.

5. The image surveillance system as recited in claim 4, wherein the image compression standard comprises an H.264 compression standard, a moving picture expert group 4 compression standard, or a motion joint photographic coding expert group compression standard.

6. The image surveillance system as recited in claim 1, wherein the first digital modulating module is connected to the image capturing module through a first data transmission interface.

7. The image surveillance system as recited in claim 6, wherein the first data transmission interface is a serial peripheral interface, a universal serial bus interface, or a secure digital input/output interface.

8. The image surveillance system as recited in claim 1, wherein the multimedia module is connected to the second digital modulating module through a second data transmission interface.

9. The image surveillance system as recited in claim 8, wherein the second data transmission interface is a serial peripheral interface, a universal serial bus interface, or a secure digital input/output interface.

10. The image surveillance system as recited in claim 1, wherein the first digital modulator and the second digital modulator adopt a modulating scheme comprising orthogonal frequency divisional multiplexing, frequency shift keying, or phase shift keying.

11. The image surveillance system as recited in claim 1, wherein the image capturing module receives electric power and a control signal through the coaxial cable.

12. An image capturing apparatus configured for an image surveillance system, the image capturing apparatus comprising:
a lens module;
a photosensitive device sensing a light source received by the lens module and producing an image signal;
an image processing module coupled to the photosensitive device, the image processing module performing an image processing task on the image signal;
a first digital modulating module comprising a first digital modulator and a first analog-to-digital/digital-to-analog converter, the first digital modulator being electrically connected to the image processing module, receiving the image signal processed by the image processing module, and modulating the image signal into a digital stream; and
a coaxial cable joint electrically connected to the first analog-to-digital/digital-to-analog converter to transmit the digital stream to a multimedia module through a coaxial cable for displaying or storing.

13. The image capturing apparatus as recited in claim 12, further comprising:
a pan tilt zoom control module electrically connected to the first digital modulating module to control a capturing direction of the lens module and to produce a zoom-in or zoom-out image signal.

14. The image capturing apparatus as recited in claim 12, wherein the image processing module compresses the image signal by applying an image compression standard and provides the first digital modulating module with the compressed image signal for modulation.

15. The image capturing apparatus as recited in claim 14, wherein the image compression standard comprises an H.264 compression standard, a moving picture expert group 4 compression standard, or a motion joint photographic coding expert group compression standard.

16. The image capturing apparatus as recited in claim 12, wherein the first digital modulator modulates the image signal into the digital stream by adopting a modulating scheme, and the modulating scheme comprises orthogonal frequency divisional multiplexing, frequency shift keying, or phase shift keying.

17. A multimedia apparatus configured for an image surveillance system and adapted to receive a digital stream produced by an image capturing apparatus, the multimedia apparatus comprising:
a coaxial cable joint;
a second digital modulating module electrically connected to the coaxial cable joint, the second digital modulating module comprising a second digital modulator and a second analog-to-digital/digital-to-analog converter, the second digital modulating module receiving the digital stream through a coaxial cable and modulating the digital stream into image data; and
a multimedia module connected to the second digital modulating module through a second data transmission interface, the multimedia module receiving the image data modulated by the second digital modulating module and displaying or storing the image data.

18. The multimedia apparatus as recited in claim 17, wherein the second data transmission interface is a serial peripheral interface, a universal serial bus interface, or a secure digital input/output interface.

19. The multimedia apparatus as recited in claim 17, wherein the second digital modulator modulates the digital stream into the image signal by adopting a modulating scheme, and the modulating scheme comprises orthogonal frequency divisional multiplexing, frequency shift keying, or phase shift keying.

20. The multimedia apparatus as recited in claim 17, wherein the second digital modulating module further receives a control signal from the multimedia module through an EIA RS232 interface or an inter integrated circuit serial communication interface.

21. An image surveillance system comprising:
an image capturing module producing an image signal;
a first digital modulating module comprising a first digital modulator and a first analog-to-digital/digital-to-analog converter, the first digital modulator being electrically connected to the image capturing module, receiving the image signal, and modulating the image signal into a digital stream;
a second digital modulating module comprising a second digital modulator and a second analog-to-digital/digital-to-analog converter, the second analog-to-digital/digital-to-analog converter being connected to the first analog-to-digital/digital-to-analog converter through a transmission line, the second digital modulator receiving the digital stream and modulating the digital stream into image data; and
a multimedia module electrically connected to the second digital modulating module, the multimedia module receiving the image data,
wherein the image capturing module receives electric power and a control signal through the transmission line.

22. The image surveillance system as recited in claim 21, wherein the transmission line is a coaxial cable, a power line, or an ethernet network cable.

23. The image surveillance system as recited in claim 21, wherein the first digital modulator modulates the image signal into the digital stream by adopting a modulating scheme, and the modulating scheme comprises orthogonal frequency divisional multiplexing, frequency shift keying, or phase shift keying.

24. The image surveillance system as recited in claim 21, wherein the image capturing module compresses the image signal by applying an image compression standard and provides the first digital modulating module with the compressed image signal for modulation.

25. The image surveillance system as recited in claim 24, wherein the image compression standard comprises an H.264 compression standard, a moving picture expert group 4 compression standard, or a motion joint photographic coding expert group standard
